(19) United States
(12) Patent Application Publication
(10) Pub. No.: US 2025/0342520 A1
(43) Pub. Date: Nov. 6, 2025

(54) VIRTUAL REALITY ECOMMERCE SYSTEM

(71) Applicant: Zenni Optical, Inc., Novato, CA (US)

(72) Inventors: Steven LEE, Barrington, IL (US); Yu Julia ZHEN, Novato, CA (US); ChyrSong TING, Novato, CA (US); Sophia MOH, Daly City, CA (US); Matthew James GOLINO, Brookhaven, GA (US); Justin Paul DEMPSEY, Ottawa (CA); Jeffrey Joseph FILLINGHAM, Dartmouth (CA)

(21) Appl. No.: 19/197,903

(22) Filed: May 2, 2025

Related U.S. Application Data
(60) Provisional application No. 63/642,571, filed on May 3, 2024.
(60) Provisional application No. 63/642,583, filed on May 3, 2024.
(60) Provisional application No. 63/642,593, filed on May 3, 2024.
(60) Provisional application No. 63/642,604, filed on May 3, 2024.
(60) Provisional application No. 63/644,457, filed on May 8, 2024.

(51) Int. Cl. G06Q 30/0601; G06F 3/01; G06F 3/16; G06Q 20/40

(52) U.S. Cl. CPC G06Q 30/0643; G06F 3/011; G06F 3/016; G06F 3/167; G06Q 20/40145; G06Q 30/0631

(57) ABSTRACT

The present disclosure relates to systems and methods of facilitating a virtual reality (VR) ecommerce transaction, such as an immersive VR ecommerce transaction. The system can include a head-mounted display designed for rendering a virtual environment. The display can receive inputs through a variety of user interface mechanisms. The system can include an input device, either integrated with the head-mounted display or operable within the virtual environment, for capturing user interactions related to the ecommerce checkout process. The system can include a processor communicatively coupled to the head-mounted display and the at least one input device. The processor can dynamically generate a virtual environment representative of a checkout interface that is adaptable to multiple ecommerce platforms. Optionally, the system can process user interactions within the virtual checkout interface, for example, including product selection, payment information entry, and shipping details confirmation, to complete real-world transactions.

### CROSS-REFERENCE TO RELATED APPLICATIONS

The present application claims priority under 35 U.S.C. 119 (e) to, and the benefit of, U.S. Provisional App. No. 63/642,571, filed on May 3, 2024, the entirety of which is incorporated herein by reference. The present application also claims priority under 35 U.S.C. 119 (e) to, and the benefit of, U.S. Provisional App. No. 63/642,583, filed on May 3, 2024, U.S. Provisional App. No. 63/642,593, filed on May 3, 2024, U.S. Provisional App. No. 63/642,604 filed on May 3, 2024, U.S. Provisional App. No. 63/644,457, May 8, 2024, the entirety of each of which is incorporated herein by reference.

### TECHNICAL FIELD

The present inventions relate to virtual and/or extended reality-based information systems that facilitate immersive user experience. More specifically, methods, systems, devices, and non-statutory computer-readable storage media are applied to implement an interactive and personalized information presentation process in an extended reality environment.

### SUMMARY

Some implementations of this application are directed to a method for facilitating an immersive virtual reality (VR) transaction. The method is implemented at an electronic system including a VR headset. The method can include dynamically generating a virtual environment representative of a virtual checkout interface adaptable to a plurality of VR information platforms, displaying, within the VR headset, the virtual environment representative of the virtual checkout interface, detecting user interactions within the virtual environment via an input device, processing the user interactions within the virtual checkout interface to determine checkout data associated with the user interactions. The checkout data can be associated with one or more of product selection, payment information entry, and shipping details confirmation.

The method further can include securely transmitting the checkout data to a backend system of one of the plurality of VR information platform via a secure communication channel. The checkout data can be processed by the backend system to generate a user message.

The method further can include securely receiving the user message from the backend system of the one of the plurality of VR information platform via the secure communication channel and presenting the user message in the virtual environment.

Some implementations of this application are directed to a VR-based information system that enables a personalized virtual showroom function with real time adjustment. The VR-based information system dynamically adjusts a virtual showroom based on a user's personal preferences and historical interaction data, offering customized shopping experience that anticipates user needs and preferences.

In some embodiments, the VR-based information system can integrate a recommendation engine that tracks user behavior within an associated VR environment, and combine real-time data analytics with predictive algorithms to customize product displays, pricing, and promotions. Further, in some embodiments, the VR-based information system learns from each user interaction to refine recommendations. In some embodiments, the VR-based information system is integrated with an inventory management system to selectively showcase products available in a user's size, style preference, or other parameters in an efficiently manner.

For example, data stored in a catalog database can be reorganized for prompt data extraction and apparel visualization. In some embodiments, the VR-based information system is configured to enable a data flow from a user interaction tracking module to a recommendation engine and further to a real-time display module in the VR environment.

In one aspect, a method is implemented for providing a VR checkout system. The method can include configuring a VR headset to display a virtual checkout environment tailored to a context, integrating an input device with the VR headset for user interaction within the virtual environment, developing and integrating software modules responsible for generating the virtual checkout interface, and enabling communication with VR information platforms for secure data transmission.

In some embodiments, an embodiment of a presently disclosed method can be implemented at an electronic device having a head-mounted display (HMD), an input device, one or more processors, and memory storing one or more programs to be executed by the one or more processors for immersive information presentation. The method can include executing a virtual reality (VR) user application, displaying, on the HMD, visual content to create a virtual environment including a VR user interface where an information item is presented, and while the VR user interface is displayed, detecting, by the input device, a user action associated with an information item presented on the VR user interface.

The method further can include in response to the user action, generating a user request associated with the information item for one or more of product selection, payment information entry, and shipping detail confirmation in the virtual environment. The method further can include transmitting the user request associated with the information item to a server system associated with the VR user application via a secure communication channel.

Some implementations of this application are directed to a system including a head-mounted display for rendering a virtual environment and receiving inputs through a variety of user interface mechanisms, at least one input device for capturing user interactions in a checkout process, a communication interface, one or more processors coupled to the communication interface, and memory storing one or more programs for execution by the one or more processors. The at least one input device is integrated with the head-mounted display or operable within the virtual environment. The one or more processors can be communicatively coupled to the head-mounted display and the at least one input device. The one or more programs further include instructions for performing any of the above methods.

Some implementations of this application are directed to a non-transitory computer readable storage medium, storing one or more programs for execution by one or more processors of a system, the one or more programs including instructions for performing any of the above methods.

In some embodiments, a user application is implemented by a head-mounted display device (HDD) configured to create a customized extended reality (XR) environment for a user engaged on an XR information platform (e.g., a customer visiting an online shopping application). Products may be rendered for the user in a three-dimension format in the XR environment, thereby facilitating product selection and fitting. The XR is an umbrella term encapsulating Augmented Reality (AR), Virtual Reality (VR), Mixed Reality (MR), and everything in between. In this application, any embodiments that apply a VR system can be implemented using an AR or MR system as well.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE FIGURES

For a better understanding of the various described implementations, reference should be made to the Description of Implementations below, in conjunction with the following drawings in which like reference numerals refer to corresponding parts throughout the figures.

FIG. 1 is a data processing environment having a plurality of servers communicatively coupled to a plurality of client devices, in accordance with some embodiments.

FIG. 2 is a visual acuity assessment environment in which an XR device (e.g., a VR headset) is applied to execute a user application and create a virtual environment, in accordance with some embodiments.

FIG. 3 is a block diagram of a computer system configured to implement a virtual reality user application, in accordance with some embodiments.

For illustrating the overcoming of pixel density limitations through algorithmic enhancement, aspects of the present disclosure can be illustrated with a diagram showcasing the process from optotype selection, through algorithmic enhancement, to display on the VR headset, highlighting the steps taken to adjust for pixel density limitations.

Before and after images can be included as comparative images showing optotypes displayed on VR headsets with or without an algorithmic enhancement, which is optional in some embodiments, thus clearly demonstrating the improvement in clarity and visibility.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description can include specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

In some embodiments, a system may include a system for facilitating an immersive virtual reality (VR) ecommerce transaction and process user interactions within the virtual checkout interface. The system may also include a head-mounted display designed for rendering a virtual environment, capable of receiving inputs through a variety of user interface mechanisms. The system may also include at least one input device, either integrated with the head-mounted display or operable within the virtual environment, for capturing user interactions related to the ecommerce checkout process. The system may also include a processor communicatively coupled to the head-mounted display and the at least one input device, the processor configured to execute one or more programs to render the virtual environment. The system may also include a communication interface integrated with the processor, enabling encrypted communication with the back-end system of the ecommerce platform.

Some implementations are directed to dynamically generating a virtual environment representative of a checkout interface adaptable to multiple ecommerce platforms. A process of user interactions may include product selection. The process of user interactions may also include payment information entry, shipping details confirmation, securely transmitting checkout data to a back-end system of an ecommerce platform, and facilitating a comprehensive checkout experience.

In some embodiments, the method may include displaying within the VR headset a virtual environment that simulates a checkout interface. The method may include receiving user interactions via an input device for product selection, payment information entry, and shipping details confirmation within the virtual environment. The method may include processing these interactions and securely transmitting the checkout data to a selected ecommerce platform's back-end system through a secure communication channel. A method for conducting a virtual reality (VR) ecommerce transaction using a VR headset may include performing one or more additional steps.

In some embodiments, an optional online portal linking and data synchronization may include an optional link to an online portal allowing users to connect their VR ecommerce experience with their existing online account on the ecommerce platform and a data synchronization module configured to synchronize user account information and stored payment details between the VR environment and the online user account.

In some embodiments, a customizable VR product display may also include a product display module capable of generating three-dimensional representations of products within the VR checkout interface, enabling detailed inspection and interaction by the user.

In some embodiments, a payment gateway integration may also include a secure payment gateway within the processor for processing payment information entered by the user within the VR environment, using established encryption protocols.

In some embodiments, a user authentication may also include A user authentication module integrated with the VR headset, utilizing biometric authentication methods for verifying the user's identity before initiating the checkout process.

In some embodiments, a multi-platform ecommerce support may also include Interface with the back-end systems of multiple ecommerce platforms, allowing user selection and use of their preferred platform within the VR checkout process.

In some embodiments, the virtual environment may be configured to: customize the checkout interface and functionalities based on the category of product being purchased, such as incorporating virtual try-on features for clothing items.

In some embodiments, a real-time delivery service integration may also include access and display real-time delivery service information within the VR checkout interface, enabling users to choose preferred delivery options and view estimated delivery times.

In some embodiments, a VR checkout gamification may include a gamification module within the virtual environment that integrates elements of gamification to promote user engagement and incentivize purchase behavior.

In some embodiments, the processor may be further configured to: automatically retrieve and utilize user-specific information like shipping address and preferred payment method from stored profiles for a streamlined checkout process.

In some embodiments, a voice command interaction may also include voice command recognition within the VR checkout interface, providing an alternative, hands-free method for user interaction.

In some embodiments, a haptic feedback integration may also include A mechanism for providing haptic feedback in response to user interactions with virtual elements, enhancing the tactile aspect of the VR experience.

In some embodiments, a system may maintain a communication link with the ecommerce platform's back-end to offer real-time inventory status, aiding in the prevention of sales of out-of-stock items.

In some embodiments, a VR order tracking functionality may also include Tracking of order progress and shipment status updates within the VR environment, providing users with real-time information on their purchases.

In some embodiments, the virtual environment may be further adapted to automatically adjust the displayed language of the checkout interface based on user preferences or regional settings, thereby facilitating a more inclusive and personalized shopping experience.

In some embodiments, the processor may be further configured to utilize user behavior and purchase history data within the VR environment to generate personalized product recommendations, which may be strategically displayed within the VR checkout interface.

In some embodiments, a VR checkout may also include Integration with loyalty programs of the selected ecommerce platform, enabling users to accrue and redeem loyalty points during the checkout process within the VR environment.

In some embodiments, the processor may be additionally configured to: collect and analyze user interaction data within the VR checkout interface anonymously for the purpose of optimizing the VR ecommerce experience based on user behavior analytics.

In some embodiments, the method may include configuring a VR headset to display a virtual checkout environment tailored to the ecommerce context. The method may include integrating an input device with the VR headset for user interaction within the virtual environment. The method may include Developing and integrating software modules responsible for generating the VR checkout interface, enabling communication with ecommerce platforms, and ensuring secure data transmission. A method for manufacturing a VR ecommerce checkout system may include performing one or more additional steps.

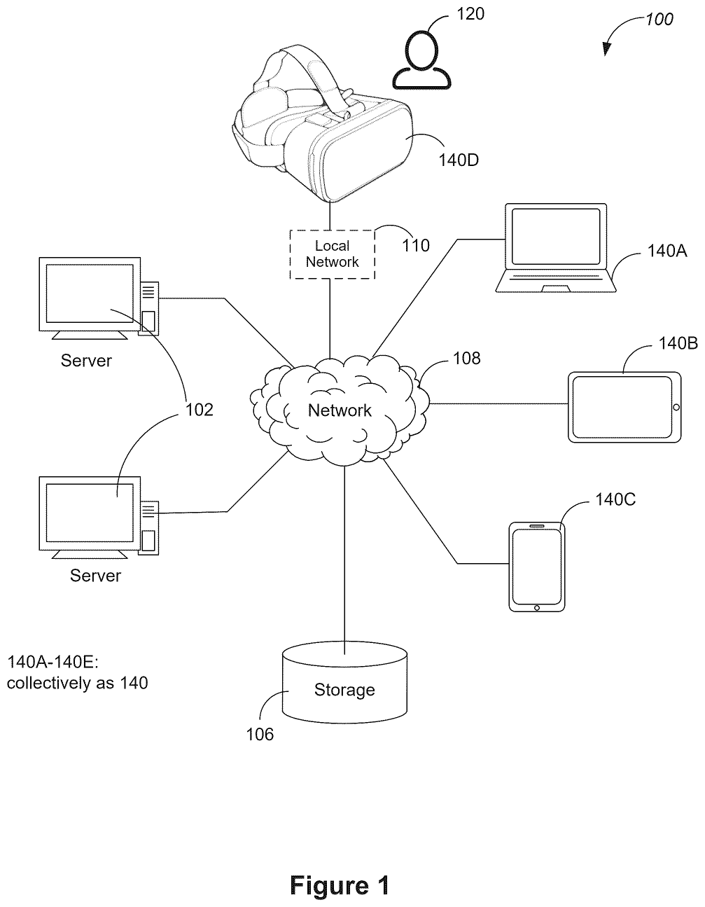

FIG. 1 is a data processing environment 100 having a plurality of servers 102 communicatively coupled to a plurality of client devices 140A-140E, in accordance with some embodiments. Each client device 140 can collect data or user inputs (e.g., image data of a user), executes user applications, and present outputs (e.g., a visual representation of a physical item) on its user interface. The collected data or user inputs can be processed locally at the client device 140 and/or remotely by the server(s) 102. The plurality of servers 102 provides system data (e.g., boot files, operating system images, and user applications) to the client devices 140, and in some embodiments, processes the data and user inputs received from the client device(s) 140 when the user applications are executed on the client devices 140. In some implementations, the data processing environment 100 further can include a storage 106 for storing data related to the servers 102, client devices 140, and applications executed on the client devices 140.

For example, storage 106 may store one or more of: video content, static visual content, audio data, user preferences, user profiles, virtual fitting parameters, and fitting instructions.

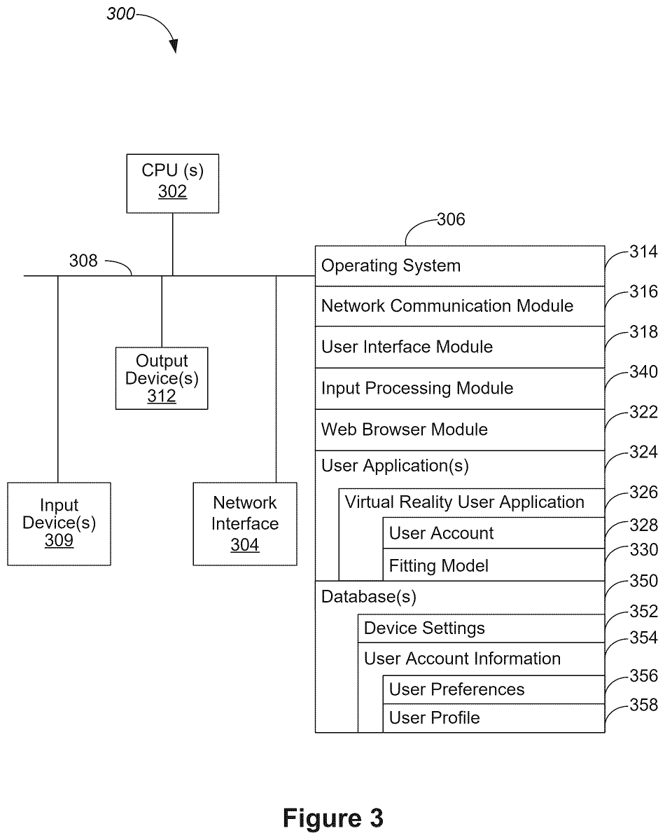

In some implementations, the plurality of servers 102 are configured to enable an VR information platform having a plurality of user accounts 328 (FIG. 3) for a plurality of users 120. Each of the plurality of client devices 140A-140E is associated with a respective user 120, and configured to execute a dedicated or browser-based user application 326 (FIG. 3). The plurality of client devices 140 may be, for example, desktop computers, laptop computers 140A, tablet computers 140B, mobile phones 140C, or intelligent, multi-sensing, network-connected home devices (e.g., a depth camera, a visible light camera 140E). In some implementations, the plurality of client devices 140 include an XR device 140D (also called a head-mounted display device (HDD) 140D) configured to render extended reality content, e.g., facilitating virtual fitting of clothes.

The plurality of servers 102 can enable real-time data communication with the client devices 140 that are remote from each other or from the plurality of servers 102. Further, in some embodiments, the plurality of servers 102 can implement data processing tasks that cannot be or are preferably not completed locally by the client devices 140.

For example, the client devices 140 include executes an interactive user application 326 (FIG. 3). The client devices 140 captures the image data of a user 120, and sends the image data to the server 102.

In some implementations, one of a plurality of user applications 326 is executed by the XR device 140 associated with a user 120. A virtual environment representative of a virtual checkout interface is generated and dynamically adjusted for a respective one of a plurality of VR information platforms associated with the executed user application 326. The virtual environment representative of the virtual checkout interface is rendered (e.g., displayed) within the VR headset. User interactions are detected within the virtual environment via an input device, and processed within the virtual checkout interface to determine checkout data associated with the user interactions. The checkout data are associated with one or more of product selection, payment information entry, and shipping details confirmation. The checkout data are securely transmitted to a backend system of one of the plurality of VR information platforms via a secure communication channel, and processed by the backend system to generate a user message. The user message can be received from the backend system of the one of the plurality of VR information platform via the secure communication channel, and presented in the virtual environment created on the XR device 140D.

The plurality of servers 102, the plurality of client devices 140, and storage 106 are communicatively coupled to each other via one or more communication networks 108, which are the medium used to provide communications links between these devices and computers connected together within the data processing environment 100. The one or more communication networks 108 may include connections, such as wire, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 108 may be established either directly (e.g., using 3G/4G/5G connectivity to a wireless carrier), or through a network interface 110 (e.g., a router, switch, gateway, hub, or an intelligent, dedicated whole-home control node), or through any combination thereof. As such, the one or more communication networks 108 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other electronic systems that route data and messages.

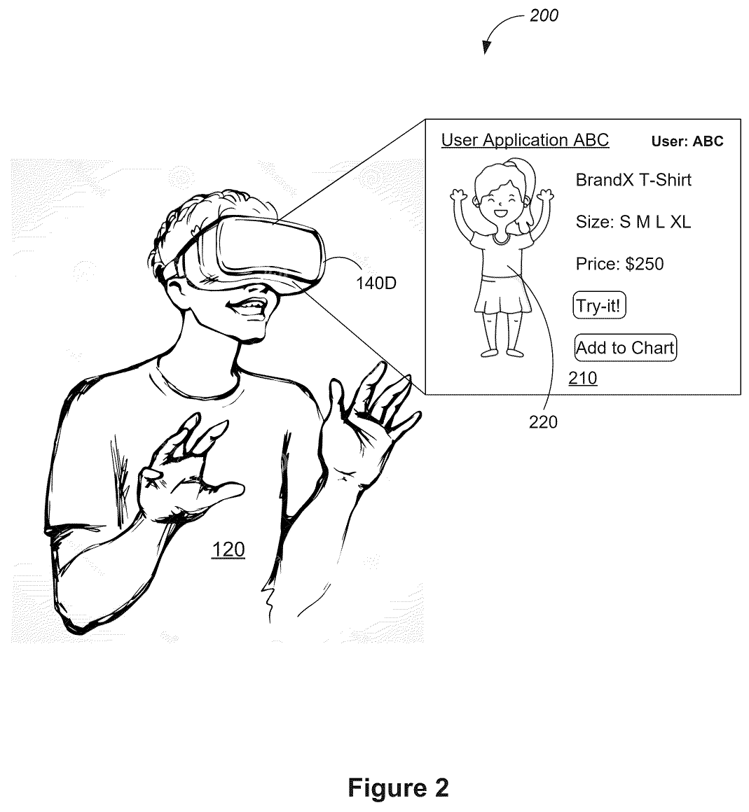

FIG. 2 is a visual acuity assessment environment in which an XR device 140D is applied to execute a user application and create a virtual environment, in accordance with some embodiments. The XR device 140D may be communicatively coupled within the data processing environment 100. The XR device 140D may include one or more cameras (e.g., a visible light camera, a depth camera), a microphone, a speaker, one or more inertial sensors (e.g., gyroscope, accelerometer), and a display. In some situations, the camera captures hand gestures of a user wearing the XR device 140D. In some situations, the microphone records ambient sound, including user's voice commands. The XR device 140D may execute a client-side user application 326 (FIG. 3) via a user account 328 associated with a user 120.

In some embodiments, a user 120 may review product options offered by the VR information platform in a three-dimensional (3D) format in the XR device 140D. A server 102 or a client device 140 associated with a user 120 may execute a user application 326 to select and present the product options based on user preferences 356 and a user profile (FIG. 3) of the user 120E. In some implementations, the XR device 140 may obtain image data of the user 120 captured by a remote imaging device, extracts biometric information (e.g., face shape, height, body built) of the user 120, create a 3D avatar of a model or the user 120, and displays a visual representation 2220 of a selected product option on the 3D avatar. Particularly, in some implementations, the user application 326 customizes a virtual fitting parameter of the selected product option reflects it on the visual representation 2220 on the 3D avatar. As such, the user application 326 enables personalized virtual fitting remotely using interactive 3D user interfaces 2210 of the XR device 140D, digital imaging, and automated measurements techniques.

In some embodiments, a client device 140 (e.g., the XR device 140D) receives, on the user interface 2210, a user input (e.g., a hand gesture, a voice message) requesting a modification to the virtual representation 2220. The user input may select the modification from a plurality of adjustment suggestions. Based on the user input, the virtual representation 2220 is modified and updated on the virtual user interface 2210.

FIG. 3 is a block diagram of a computer system 300 configured to implement a virtual reality user application, in accordance with some embodiments. The computer system 300 typically, can include one or more processing units (CPUs) 302, one or more network interfaces 304, memory 306, and one or more communication buses 308 for interconnecting these components (sometimes called a chipset). The computer system 300 can include one or more input devices 309 that facilitate user input, such as a keyboard, a mouse, a voice-command input unit or microphone, a touch screen display, a touch-sensitive input pad, a gesture capturing camera, or other input buttons or controls. Furthermore, in some embodiments, the client device 140 of the computer system 300 uses a microphone for voice recognition or an eye tracking device 380 (e.g., a camera) for tracking eyeball movement. In some implementations, the client device 140 can include one or more optical cameras (e.g., an RGB camera), scanners, or photo sensor units for capturing images. The computer system 300 also can include one or more output devices 312 that enable presentation of user interfaces 2210 and display content, including one or more speakers and/or one or more visual displays.

Memory 306 can include high-speed random-access memory, such as DRAM, SRAM, DDR RAM, or other random access solid state memory devices; and, optionally, can include non-volatile memory, such as one or more magnetic disk storage devices, one or more optical disk storage devices, one or more flash memory devices, or one or more other non-volatile solid state storage devices. Memory 306, optionally, can include one or more storage devices remotely located from one or more processing units 302. Memory 306, or alternatively the non-volatile memory within memory 306, can include a non-transitory computer readable storage medium. In some implementations, memory 306, or the non-transitory computer readable storage medium of memory 306, stores the following programs, modules, and data structures, or a subset or superset thereof:
Operating system 314 including procedures for handling various basic system services and for performing hardware dependent tasks;
Network communication module 316 for connecting each server 102 or client device 140 to other devices (e.g., server 102, client device 140, or storage 106) via one or more network interfaces 304 (wired or wireless) and one or more communication networks 108, such as the Internet, other wide area networks, local area networks, metropolitan area networks, and so on;
User interface module 318 for enabling presentation of information (e.g., a graphical user interface for application(s) 324, widgets, websites and web pages thereof, and/or games, audio and/or video content, text, etc.) at each client device 140 via one or more output devices 312 (e.g., displays, speakers, etc.);
Input processing module 340 for detecting one or more user inputs or interactions from one of the one or more input devices 309 and interpreting the detected input or interaction;
Web browser module 322 for navigating, requesting (e.g., via HTTP), and displaying websites and web pages thereof, including a web interface for logging into a user account associated with a client device 140 or another electronic device, controlling the client or electronic device if associated with the user account, and editing and reviewing settings and data that are associated with the user account;
User applications 324 for execution by the computer system 300 (e.g., games, social network applications, smart home applications, extended reality application, and/or other web or non-web based applications for controlling another electronic device and reviewing data captured by such devices), where in some embodiments, a plurality of virtual reality (VR) user application 326 are executed to enable a plurality of VR information platforms, and each VR user application 326 is configured to present information of items, implement virtual fitting, and process information processing requests (e.g., ordering, shipping), and has a plurality of respective user accounts 328 associated with a plurality of users 120 each of which interacts with the plurality of VR information platforms via a respective HMD 140D; and
One or more databases 350 for storing at least data including one or more of:

Device settings 352 including common device settings (e.g., service tier, device model, storage capacity, processing capabilities, communication capabilities, etc.) of the computer system 300; and

User account information 354 for the one or more user applications 324, e.g., user names, security questions, account history data, user preferences, and predefined account settings, where in some embodiments, the user account information 354 of each user account 328 can include user preferences 356 and a user profile 358 associated with a respective user 120 on a respective VR information platform hosted on a respective VR user application 326.

In some embodiments, a VR user application 326 applies a fitting model 330 to determine a virtual fitting parameter of a product for a user 120.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some implementations, memory 306, optionally, stores a subset of the modules and data structures identified above. Furthermore, memory 306, optionally, stores additional modules and data structures not described above.

In some embodiments, a VR-based information system is implemented using one or more of: cross-platform development kits, dynamic resolution scaling, platform-specific input handling, user experience (ux) adaptability, platform detection and optimization, middleware integration, modular design, and cloud-based services. Developers may use cross-platform SDKs that provide a unified API, allowing the same code to interface with different VR platforms. Dynamic Resolution Scaling adjusts the resolution on-the-fly to maintain optimal performance across different hardware capabilities. Each VR platform can have its unique input devices (controllers, gesture recognition, etc.), and the VR information platform can include an abstraction layer to interpret these inputs consistently in the virtual environment. Since different VR platforms may have different UX conventions, the VR-based information system may dynamically alter layout or interaction methods to conform to the expected norms of each platform. The system could detect the specific VR platform at runtime and adjust settings or features to optimize performance for that particular environment. By incorporating middleware solutions that are compatible across various platforms, the VR-based information system can provide features like physics simulations and audio processing uniformly. Having a modular design for the checkout interface can allow for specific features or components to be enabled or disabled depending on the platform's capabilities. Using cloud services for backend processes like inventory management and payment processing can ensure a consistent experience across platforms.

In some embodiments, a VR-based information system can include a secure payment gateway established by one or more of: integration with payment service providers, implementing encryption protocols, and compliance with standards, authentication and authorization. The VR-based information system collaborates with companies that offer payment processing services to facilitate financial transactions, utilizes standard encryption methods such as SSL (Secure Socket Layer) or TLS (Transport Layer Security) to safeguard sensitive data like credit card numbers, adheres to payment industry standards such as PCI DSS (Payment Card Industry Data Security Standard) to ensure the secure handling of credit card information, and implements user authentication and transaction authorization mechanisms to validate transactions.

Further, in some embodiments, the VR-based information system is switched among different gateways used by different platforms. Modular Gateway Interfaces may be provided using modular programming, and are configured to receive instructions to switch out payment gateway modules as required by the transaction or user preference. Gateway agnostic application programming interfaces (APIs) are used to interact with various payment gateways, independently regardless of their individual specifications. Dynamic configurations can be used to allow the system to configure itself dynamically to use different gateways based on the detected platform or user's location. A users may select a preferred payment method. A system may automatically select the preferred payment method based on a user preference. The preferred payment is automatically associated with the corresponding gateway.

In some embodiments, the VR headsets may have input methods for entering sensitive payment information securely. In some embodiments, the VR headsets are configured to adopt robust security protocols that have the same level of security infrastructure as mobile devices including mobile phones, tablet computers, laptops. Additionally, in some embodiments, user interface (UI) can be designed for payment within the VR environment, and has a secure and user-friendly format in the 3D space. A secure payment system may be integrated within the immersive VR environment, keeping immersive user experience without compromising security.

Biometric information can include physiological data points that are unique to an individual user, such as fingerprints, facial recognition data, iris or retina patterns, voiceprints, or even patterns of movement. In a VR environment, biometric information can be used to verify the user's identity, enhancing security, especially for processes like payments or accessing restricted content. In some embodiments, the VR-based information system is configured to enable one or more of: secure storage, decentralized systems, tokenization, data security, encryption, access controls, regular audits and compliance, hashing, physical security, multi-factor authentication, limited retention time associated with the biometric information. Biometric data is typically stored in encrypted databases. Encryption at rest ensures that even if data storage is compromised, the information remains unreadable without the decryption keys.

For example, biometric information is stored on a local device, rather than in a central database, can reduce the risk of mass data breaches. Instead of storing the biometric data directly, the VR-based information system can store a token that represents the data. The biometric information is discarded after verification. Biometric data can be encrypted both at rest and in transit using strong encryption algorithms. The VR-based information system can implement strict access controls to ensure that only authorized personnel and systems can interact with the biometric data. The VR-based information system can regularly audit the security measures and ensure compliance with relevant privacy and data protection regulations like GDPR or HIPAA. Instead of storing the actual biometric data, the VR-based information system can store a hashed version that can't be reversed-engineered to the original biometric data. If biometric data are stored on local devices, physical security measures can be applied to prevent unauthorized access. Using biometric data as part of multi-factor authentication can enhance security by requiring more than one form of verification. The VR-based information system may keep the biometric data only for a period necessary for the purpose the biometric data are collected for, and apply policies for data destruction after that period.

In some embodiments, the VR-based information system can personalize a virtual try-on feature in a 3D context using one or more of, user's avatar customization, real-time body tracking, fabric simulation, personalized style recommendations, custom fittings, interactive features, and integration with real-world data. The VR-based information system can create a 3D avatar based on the user's dimensions, which can be obtained through input measurements or scanning the user with depth-sensing cameras. Clothing items can then be rendered onto this personalized avatar in the virtual environment. The VR-based information system can utilize VR tracking technology to follow the user's movements, allowing the clothing items to move and fit realistically on the user's avatar as they would in real life. The VR-based information system can implement physics-based simulations that mimic the behavior of different fabrics. This would allow for a realistic representation of how the clothing would look, drape, and move on the user's body. The VR-based information system can use machine learning algorithms to suggest clothing items that fit the user's style preferences, body type, or previous shopping behavior. The VR-based information system can provide tools for users to adjust the size, color, or style of the clothing items in the virtual space, giving a more tailored and personalized experience. The VR-based information system can enable users to interact with the virtual clothes, such as stretching, moving, and layering items, to give a sense of how they might fit and feel. The feature could take into account current fashion trends, weather data, or the user's calendar events to suggest the most appropriate clothing options. These personalization methods enhance the user experience by making the virtual try-on feature more engaging, realistic, and useful for the user within a 3D environment.

In some embodiments, the VR-based information system is configured to implement one or more of: data preprocessing, feature extraction, machine learning algorithms, personalization engine, collaborative filtering, content-based filtering, deep learning, reinforcement learning, adaptive display, feedback loop, and security and privacy. The VR-based information system can collect comprehensive user behavior data within the VR environment, such as items viewed, time spent on certain products, user interactions, and responses to past recommendations. Purchase history data can include items bought, frequency of purchases, and transaction values. The VR-based information system can clean the data to ensure it is accurate and relevant. The VR-based information system can transform raw data into a format suitable for machine learning algorithms, such as categorizing behavior patterns or normalizing purchase amounts. The VR-based information system can identify key features from the data that are predictive of user preferences and likely purchase intent. This may include recency, frequency, monetary (RFM) metrics, item interaction types, and durations. The VR-based information system can use user-item interaction data to predict products a user might like based on the preferences of similar users. The VR-based information system can make recommendations based on the attributes of products that a user has shown interest in the past. Neural networks, possibly including recurrent neural networks (RNNs) or convolutional neural networks (CNNs), can be used to capture complex patterns and sequences in user behavior data. The VR-based information system can employ algorithms that continuously learn and optimize recommendations based on user feedback and interactions in real-time. An AI-driven personalization engine integrates the above algorithms and regularly updates its recommendation models with new user data to improve relevance. The AI-driven personalization engine can score and rank products for each user to display the most relevant recommendations. The system may use a user interface algorithm that determines the optimal time and place within the VR environment to display recommendations to maximize engagement without being obtrusive. The VR-based information system can use A/B testing modules to test and optimize the effectiveness of different recommendation strategies and display formats. The VR-based information system can implement data privacy measures to ensure user information is handled securely. The VR-based information system can utilize techniques like differential privacy during the data analysis phase to maintain user anonymity. The VR-based information system can incorporate a feedback loop where the user's interactions with the recommendations are fed back into the system, allowing the AI to learn and adjust future recommendations.

In some embodiments, the VR-based information system is configured to implement one or more of: data collection, anonymization, data transmission and storage, analytics and processing, interface update logic, feedback loop, user testing and quality assurance, and security and compliance. User interactions are tracked within the VR environment, and may include clicks, gaze tracking, item selections, navigation paths, time spent on each item, and more. VR-specific analytics tools may be used. Custom event tracking tools may be developed within the VR application to capture user interactions effectively. Before storing or analyzing the data, the VR-based information system may apply anonymization techniques to remove any personally identifiable information, ensuring compliance with privacy regulations. Random identifiers may be assigned to sessions to enable behavior tracking without revealing the user's identity. The collected data may be transmitted securely to a central analytics server or cloud-based service using encryption. The data are stored in a structured format within a database that is designed for efficient retrieval and analysis. The VR-based information system may apply data mining and machine learning algorithms to identify patterns and trends in user behavior. This can include clustering, sequence analysis, or predictive modeling. The VR-based information system may use statistical analysis to interpret the significance of various behaviors and their correlation with user satisfaction or conversion rates. Based on the insights gained from the analytics, the VR-based information system develops logic to adapt the virtual checkout interface, which may involve A/B testing different interface designs or automating the rearrangement of interface elements to optimize for user engagement and conversion. The VR-based information system can implement real-time updates to the checkout interface and collaborate with a dynamic content management system within the VR environment. The VR-based information system can establish a continuous feedback loop where the effectiveness of updates is monitored by subsequent user behavior analytics. The VR-based information system can apply machine learning models that can automatically refine the interface based on ongoing analysis, which could involve reinforcement learning or other adaptive algorithms. The VR-based information system can perform rigorous user testing to ensure that the updated interface does not diminish the user experience or introduce usability issues. The VR-based information system can monitor the performance impact of interface changes on the overall VR experience, optimizing for both user engagement and system performance. The VR-based information system can regularly review the system for compliance with data protection regulations. The VR-based information system can ensure that all analytics processes are secure against unauthorized access and data breaches.

In some embodiments, the VR-based information system is configured to support one or more of: spatial interaction, intuitive controls, immersive experience, physicality and presence, environmental context, haptic feedback, dynamic adaptability, holistic design, and multi-sensory output. Users can interact with elements in a three-dimensional space, which can include depth as an additional dimension compared to the flat screens of traditional interfaces. VR UI often involves more natural and intuitive controls, such as hand gestures or gaze-directed navigation, which aim to mimic real-world interactions. The UI is part of an immersive experience that can include a 360-degree field of view, where information can be presented in an environment that surrounds the user, rather than on a flat surface. There's a sense of physicality and presence within the VR space. Users may feel like they're truly “inside” the interface, able to look around and interact with elements as they would with physical objects. UI elements can react to the user's virtual environment, allowing for context-sensitive interactions that adjust to where the user looks or moves. The use of haptic feedback in the input devices can give tactile responses to user actions, enhancing the sense of realism and immersion. The VR UI can adapt dynamically in real-time, reconfiguring itself based on user actions or preferences. A user's field of view and how the user navigates and interacts with the UI elements using their body are enabled in the VR environment holistically. Besides visual content, VR UIs can integrate auditory and haptic outputs to create a multi-sensory experience, making information presentation richer and more engaging.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. A method for facilitating an immersive virtual reality (VR) transaction, comprising, at an electronic system including a VR headset: dynamically generating a virtual environment representative of a virtual checkout interface adaptable to a plurality of VR information platforms; displaying, within the VR headset, the virtual environment representative of the virtual checkout interface; detecting user interactions within the virtual environment via an input device; processing the user interactions within the virtual checkout interface to determine checkout data associated with the user interactions, wherein the checkout data are associated with one or more of product selection, payment information entry, and shipping details confirmation; securely transmitting the checkout data to a backend system of one of the plurality of VR information platform via a secure communication channel, wherein the checkout data are processed by the backend system to generate a user message; securely receiving the user message from the backend system of the one of the plurality of VR information platform via the secure communication channel; and presenting the user message in the virtual environment.

Clause 2. The method of Clause 1, further comprising: connecting, via an optional link to an online portal, the virtual environment with a user account on the VR information platform, and synchronizing, via a data synchronization module, user account information and stored payment details between the VR environment and the user account.

Clause 3. The method of any of the preceding Clauses, wherein generating a virtual environment further comprises: generating, by a product display module, three-dimensional (3D) representations of products within the virtual checkout interface; and displaying information items to enable detailed inspection and interaction of the products.

Clause 4. The method of any of the preceding Clauses, further comprising: establishing a secure payment gateway by the one or more processors; identifying one or more encryption protocols associated with the secure payment gateway; and processing payment information associated with one of the user interactions within the virtual environment based on the one or more encryption protocols.

Clause 5. The method of any of the preceding Clauses, further comprising: obtaining biometric information of a user associated with the VR headset; and based on the biometric information, authenticating, by a user authentication module integrated with the VR headset, identification information of the user; wherein the user interactions are processed in accordance with an authentication of the identification information of the user.

Clause 6. The method of any of the preceding Clauses, wherein the one of the plurality of VR information platform is a preferred VR information platform of a user associated with the VR headset, the method further comprising: communicatively coupling to a plurality of backend systems of the plurality of VR information platforms; and receiving a user selection of the preferred VR information platform among the plurality of VR information platform.

Clause 7. The method of any of the preceding Clauses, further comprising: determining a category of a product for which product information is displayed in the virtual environment; and customizing the virtual checkout interface and one or more associated functionalities based on the category of the product.

Clause 8. The method of any of the preceding Clauses, further comprising: determining that information of one or more clothing items is displayed in the virtual environment; displaying an affordance item associated with a virtual try-on feature; and in response to a first user interaction with the affordance item, enabling the virtual try-on feature in the virtual environment.

Clause 9. The method of any of the preceding Clauses, further comprising: obtaining real-time delivery service information; displaying the real-time delivery service information on the virtual checkout interface; wherein the user interactions select a preferred delivery option; and displaying an estimated delivery time on the virtual checkout interface.

Clause 10. The method of any of the preceding Clauses, further comprising integrating, by a gamification module within the virtual environment, one or more gamification elements to promote user engagement and incentivize purchase behavior.

Clause 11. The method of any of the preceding Clauses, further comprising automatically retrieving and utilizing user-specific information including a shipping address and a preferred payment method from a user profile associated with the VR headset for a streamlined checkout process.

Clause 12. The method of any of the preceding Clauses, detecting the user interactions further comprising: receiving a voice command in the virtual checkout interface; and recognizing the voice command to provide an alternative hands-free method for the user interactions.

Clause 13. The method of any of the preceding Clauses, further comprising, at the VR headset detecting a haptic feedback in response to the user interactions associated with one or more virtual elements enabled in the virtual environment.

Clause 14. The method of any of the preceding Clauses, further comprising: establishing the secure communication channel with the backend system of the one of the plurality of VR information platforms; receiving, via the secure communication channel, real-time inventory status; and in accordance with a determination that an item is out of stock, displaying information of the item indicating that the item is out of stock.

Clause 15. The method of any of the preceding Clauses, wherein the user message includes information of order progress and shipment status within the VR environment, further comprising: receiving an update of the user message; and updating display of the user message in real time.

Clause 16. The method of any of the preceding Clauses, further comprising: determining a user preference of a user associated with the VR headset or a regional setting of a region where the VR headset is located; and automatically adopting or adjusting a language used by the virtual checkout interface based on the user preference or regional setting.

Clause 17. The method of any of the preceding Clauses, further comprising: obtaining user information including user behavior data and purchase history data within the VR environment; generating a personalized product recommendation based on the user information; and adaptively displaying the personalized product recommendation on the virtual checkout interface.

Clause 18. The method of any of the preceding Clauses, further comprising: determining that a user account associated with the VR headset is enrolled with a loyalty program of the VR information platform; and accruing and redeeming loyalty points associated with the user account based on the user interactions.

Clause 19. The method of any of the preceding Clauses, further comprising: collecting and analyzing user interaction data via the virtual checkout interface anonymously to generate user behavior analytics information; and updating the virtual checkout interface based on the user behavior analytics information.

Clause 20. A method for manufacturing a VR checkout system, comprising: configuring a VR headset to display a virtual checkout environment tailored to a context; integrating an input device with the VR headset for user interaction within the virtual environment; developing and integrating software modules responsible for generating the virtual checkout interface; and enabling communication with VR information platforms for secure data transmission.

Clause 21. A method for immersive information presentation, comprising: at an electronic device having a head-mounted display (HMD), an input device, one or more processors, and memory storing one or more programs to be executed by the one or more processors: executing a virtual reality (VR) user application; displaying, on the HMD, visual content to create a virtual environment including a VR user interface where an information item is presented; while the VR user interface is displayed, detecting, by the input device, a user action associated with an information item presented on the VR user interface; in response to the user action, generating a user request associated with the information item for one or more of product selection, payment information entry, and shipping detail confirmation in the virtual environment; and transmitting the user request associated with the information item to a server system associated with the VR user application via a secure communication channel.

Clause 22. A system, comprising: a head-mounted display for rendering a virtual environment and receiving inputs through a variety of user interface mechanisms; at least one input device for capturing user interactions in a checkout process, wherein the at least one input device is integrated with the head-mounted display or operable within the virtual environment; a communication interface; one or more processors coupled to the communication interface, wherein the one or more processors are communicatively coupled to the head-mounted display and the at least one input device; and memory storing one or more programs for execution by the one or more processors, the one or more programs further comprising instructions for performing the method of any of Clauses 1-21.

Clause 23. A non-transitory computer readable storage medium, storing one or more programs for execution by one or more processors of a system, the one or more programs including instructions for performing a method in any of Clauses 1-21.

Clause 24. A method for conducting a virtual reality (VR) transaction using a VR headset, the method comprising: displaying within the VR headset a virtual environment that simulates a checkout interface; receiving user interactions via an input device for product selection, payment information entry, and shipping details confirmation within the virtual environment; and processing these interactions and securely transmitting the checkout data to a selected platform's backend system through a secure communication channel.

Clause 25. A system for facilitating an immersive virtual reality (VR) transaction, the system comprising: a head-mounted display designed for rendering a virtual environment, capable of receiving inputs through a variety of user interface mechanisms; at least one input device, either integrated with said head-mounted display or operable within the virtual environment, for capturing user interactions related to the checkout process; a processor communicatively coupled to the head-mounted display and the at least one input device, the processor configured to: dynamically generate a virtual environment representative of a checkout interface adaptable to a plurality of platforms; process user interactions within the virtual checkout interface including product selection, payment information entry, and shipping details confirmation; and securely transmit checkout data to a backend system of an platform, facilitating a comprehensive checkout experience; and a communication interface integrated with the processor, enabling encrypted communication with the backend system of the platform.

Clause 26. The system of Clause 25, further comprising: an optional link to an online portal allowing users to connect their VR experience with their existing online account on the platform; and a data synchronization module configured to synchronize user account information and stored payment details between the VR environment and the online user account.

Clause 27. The system of any of Clauses 25 to 26, wherein the virtual environment includes a product display module capable of generating three-dimensional representations of products within the VR checkout interface, enabling detailed inspection and interaction by the user.

Clause 28. The system of any of Clauses 25-27, further configured to include a secure payment gateway within the processor for processing payment information entered by the user within the VR environment, using established encryption protocols.

Clause 29. The system of any of Clauses 25-28, further comprising a user authentication module integrated with the VR headset, utilizing biometric authentication methods for verifying the user's identity before initiating the checkout process.

Clause 30. The system of any of Clauses 25-29, wherein the processor is additionally configured to interface with the backend systems of a plurality of platforms, allowing user selection and use of their preferred platform within the VR checkout process.

Clause 31. The system of any of Clauses 25-30, wherein the virtual environment is configured to customize the checkout interface and functionalities based on the category of product being purchased, such as incorporating virtual try-on features for clothing items.

Clause 32. The system of any of Clauses 25-31, wherein the processor is further adapted to access and display real-time delivery service information within the VR checkout interface, enabling users to choose preferred delivery options and view estimated delivery times.

Clause 33. The system of any of Clauses 25-32, further comprising a gamification module within the virtual environment that integrates elements of gamification to promote user engagement and incentivize purchase behavior.

Clause 34. The system of any of Clauses 25-33, wherein the processor is further configured to automatically retrieve and utilize user-specific information like shipping address and preferred payment method from stored profiles for a streamlined checkout process.

Clause 35. The system of any of Clauses 25-34, wherein the processor enables voice command recognition within the VR checkout interface, providing an alternative, hands-free method for user interaction.

Clause 36. The system of any of Clauses 25-35, wherein the VR headset includes a mechanism for providing haptic feedback in response to user interactions with virtual elements, enhancing the tactile aspect of the VR experience.

Clause 37. The system of any of Clauses 25-36, wherein the processor is further adapted to maintain a communication link with the platform's backend to offer real-time inventory status, aiding in the prevention of sales of out-of-stock items.

Clause 38. The system of any of Clauses 25-37, further configured to enable tracking of order progress and shipment status updates within the VR environment, providing users with real-time information on their purchases.

Clause 39. The system of any of Clauses 25-38, wherein the virtual environment is further adapted to automatically adjust the displayed language of the checkout interface based on user preferences or regional settings, thereby facilitating a more inclusive and personalized shopping experience.

Clause 40. The system of any of Clauses 25-39, wherein the processor is further configured to utilize user behavior and purchase history data within the VR environment to generate personalized product recommendations, which are strategically displayed within the VR checkout interface.

Clause 41. The system of any of Clauses 25-40, further comprising integration with loyalty programs of the selected platform, enabling users to accrue and redeem loyalty points during the checkout process within the VR environment.

Clause 42. The system of any of Clauses 25-41, wherein the processor is additionally configured to collect and analyze user interaction data within the VR checkout interface anonymously for the purpose of optimizing the VR experience based on user behavior analytics.

Clause 43. A method for manufacturing a VR checkout system, comprising: configuring a VR headset to display a virtual checkout environment tailored to the context; integrating an input device with the VR headset for user interaction within the virtual environment; developing and integrating software modules responsible for generating the VR checkout interface, enabling communication with platforms, and ensuring secure data transmission.

Clause 44. The method of Clause 43, further comprising any of the features or steps recited in any of the preceding Clauses.

In some implementations, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

### Further Considerations

As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to 10% percent of the actual value stated, and other suitable tolerances.

As used herein, the term “comprising” indicates the presence of the specified integer(s), but allows for the possibility of other integers, unspecified. This term does not imply any particular proportion of the specified integers. Variations of the word “comprising,” such as “comprise” and “comprises,” have correspondingly similar meanings.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above. Various other modifications, changes and variations may be made in the arrangement, operation and details of the method and apparatus of the subject technology disclosed herein without departing from the scope of the present disclosure. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. A method for facilitating an immersive virtual reality (VR) transaction, comprising, at an electronic system including a VR headset:
dynamically generating a virtual environment representative of a virtual checkout interface adaptable to a plurality of VR information platforms;
displaying, within the VR headset, the virtual environment representative of the virtual checkout interface;
detecting user interactions within the virtual environment via an input device;
processing the user interactions within the virtual checkout interface to determine checkout data associated with the user interactions, wherein the checkout data are associated with one or more of product selection, payment information entry, and shipping details confirmation;
securely transmitting the checkout data to a backend system of one of the plurality of VR information platform via a secure communication channel, wherein the checkout data are processed by the backend system to generate a user message;
securely receiving the user message from the backend system of the one of the plurality of VR information platform via the secure communication channel; and
presenting the user message in the virtual environment.

2. The method of claim 1, further comprising:
connecting, via an optional link to an online portal, the virtual environment with a user account on the VR information platform, and
synchronizing, via a data synchronization module, user account information and stored payment details between the VR environment and the user account.

3. The method of claim 1, wherein generating a virtual environment further comprises:
generating, by a product display module, three-dimensional (3D) representations of products within the virtual checkout interface; and
displaying information items to enable detailed inspection and interaction of the products.

4. The method of claim 1, further comprising:
obtaining biometric information of a user associated with the VR headset; and
based on the biometric information, authenticating, by a user authentication module integrated with the VR headset, identification information of the user;
wherein the user interactions are processed in accordance with an authentication of the identification information of the user.

5. The method of claim 1, wherein the one of the plurality of VR information platform is a preferred VR information platform of a user associated with the VR headset, the method further comprising:
communicatively coupling to a plurality of backend systems of the plurality of VR information platforms; and
receiving a user selection of the preferred VR information platform among the plurality of VR information platform.

6. The method of claim 1, further comprising:
determining a category of a product for which product information is displayed in the virtual environment; and
customizing the virtual checkout interface and one or more associated functionalities based on the category of the product.

7. The method of claim 1, further comprising:
determining that information of one or more clothing items is displayed in the virtual environment;
displaying an affordance item associated with a virtual try-on feature; and
in response to a first user interaction with the affordance item, enabling the virtual try-on feature in the virtual environment.

8. The method of claim 1, further comprising:
obtaining real-time delivery service information;
displaying the real-time delivery service information on the virtual checkout interface; wherein the user interactions select a preferred delivery option; and
displaying an estimated delivery time on the virtual checkout interface.

9. The method of claim 1, further comprising integrating, by a gamification module within the virtual environment, one or more gamification elements to promote user engagement and incentivize purchase behavior.

10. The method of claim 1, detecting the user interactions further comprising:
receiving a voice command in the virtual checkout interface; and
recognizing the voice command to provide an alternative hands-free method for the user interactions.

11. The method of claim 1, further comprising, at the VR headset detecting a haptic feedback in response to the user interactions associated with one or more virtual elements enabled in the virtual environment.

12. The method of claim 1, further comprising:
collecting and analyzing user interaction data via the virtual checkout interface anonymously to generate user behavior analytics information; and
updating the virtual checkout interface based on the user behavior analytics information.

13. A system for facilitating an immersive virtual reality (VR) transaction, the system comprising:
a head-mounted display designed for rendering a virtual environment, capable of receiving inputs through a variety of user interface mechanisms;
at least one input device, either integrated with said head-mounted display or operable within the virtual environment, for capturing user interactions related to the checkout process;
a processor communicatively coupled to the head-mounted display and the at least one input device, the processor configured to:
dynamically generate a virtual environment representative of a checkout interface adaptable to a plurality of platforms;
process user interactions within the virtual checkout interface including product selection, payment information entry, and shipping details confirmation; and
securely transmit checkout data to a backend system of an platform, facilitating a comprehensive checkout experience; and
a communication interface integrated with the processor, enabling encrypted communication with the backend system of the platform.

14. The system of claim 13, wherein the virtual environment includes a product display module capable of generating three-dimensional representations of products within the VR checkout interface, enabling detailed inspection and interaction by the user.

15. The system of claim 13, further comprising a user authentication module integrated with the VR headset, utilizing biometric authentication methods for verifying the user's identity before initiating the checkout process.

16. The system of claim 13, wherein the processor is further adapted to access and display real-time delivery service information within the VR checkout interface, enabling users to choose preferred delivery options and view estimated delivery times.

17. The system of claim 13, further comprising a gamification module within the virtual environment that integrates elements of gamification to promote user engagement and incentivize purchase behavior.

18. The system of claim 13, further configured to enable tracking of order progress and shipment status updates within the VR environment, providing users with real-time information on their purchases.

19. The system of claim 13, wherein the processor is further configured to utilize user behavior and purchase history data within the VR environment to generate personalized product recommendations, which are strategically displayed within the VR checkout interface.

20. The system of claim 13, wherein the processor is additionally configured to collect and analyze user interaction data within the VR checkout interface anonymously for the purpose of optimizing the VR experience based on user behavior analytics.
